(19) United States
(12) Patent Application Publication
(10) Pub. No.: US 2006/0123121 A1
(43) Pub. Date: Jun. 8, 2006

(54) System and method for service session management

(76) Inventors: Akira Maegawa, Yokohama (JP); Daisuke Takaya, Kamakura (JP); Kentaro Koga, Fujisawa (JP); Takahiro Inoue, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/272,870

(22) Filed: Nov. 15, 2005

(30) Foreign Application Priority Data
Nov. 22, 2004 (JP) 2004-337371

(51) Int. Cl. G06F 15/16

(52) U.S. Cl. 709/227; 709/228

(57) ABSTRACT

A session information management system is provided for efficiently processing session information in communications, and maintaining the consistency of session information among several application servers. The system comprises a plurality of first computers connected to terminals, and a second computer connected to the plurality of first computers. The second computer gives the session information an attribute indicative of the presence or absence of an update in the session information. The first computer continues a process in response to a request from one of the terminals based on the attribute of the session information given by the second computer.

The present application claims priority from Japanese application JP 2004-337371 filed on Nov. 22, 2004, the content of which is hereby incorporated by reference into this application.

### BACKGROUND OF THE INVENTION

The present invention relates to techniques of session information management for managing session information.

Conventionally, a plurality of application servers are installed in a cluster configuration for processing requests from client machines, such that the requests from the client machines are distributed to arbitrary application servers by a load distributor or the like.

When an application server fails (stops operations due to a failure or the like) while it is processing a request from a client machine, another application server must take over session information on the request to continue the processing. There are several persistances for taking over session information, including, for example, a DB (Data Base) based persistence and a memory-based persistence.

The DB-based persistence provides a DB server which is connected to all application servers for sequentially storing session information of respective application servers. Such a technique is disclosed in JP-A-2004-78552.

The memory-based persistence forces all application servers, which make up a cluster, to store a copy of session information of the respective session servers.

### SUMMARY OF THE INVENTION

However, the method described in JP-A-2004-78552 suffers from an increase in the scale of a system, difficult operations, and permanent survival of session information which is no longer necessary.

The memory-based persistence in turn has a problem of larger overhead resulting from more copies of session information as a cluster is made up of a larger number of application servers. Further, if part of a copy fails, the consistency of the session information cannot be maintained among the respective application servers.

It is therefore an object of the present invention to permit session information to be reused when a process is taken over. It is another object of the present invention to continue a process while the consistency of session information is maintained among respective application servers.

To solve the problems mentioned above, the present invention provides a session information management system which includes a plurality of first computers each for performing a process in response to a request from a terminal, and a second computer for managing session information on the request processed by each of the first computers, wherein the second computer gives the session information an attribute indicative of the presence or absence of an update in the session information, such that the first computer continues the process in response to the request from the terminal based on the attribute of the session information given by the second computer.

According to the present invention, the session information can be reused when a process is taken over.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram generally illustrating the configuration of a session information management system according to one embodiment of the present invention;

FIG. 2A is a block diagram illustrating operations performed when session information is copied in the session information management system;

FIG. 2B is a block diagram illustrating operations performed when an application server fails in the session information management system;

FIG. 2C is a block diagram illustrating operations performed when session information is rewritten in the session information management system;

FIG. 2D is a block diagram illustrating operations performed when an attribute of session information is changed in the session information management system;

FIG. 2E is a block diagram illustrating operations performed when a session information management server fails in the session information management system;

FIG. 3 is a table showing a data structure used by an HTTP session information registration unit;

FIG. 4 is a table showing a data structure used by a global session information registration unit;

FIG. 5 is a processing flow diagram when there is no HTTP session;

FIG. 6 is a processing flow diagram when there is an HTTP session;

FIG. 7 is a processing flow diagram when an HTTP session is deleted;

FIG. 8 is a processing flow diagram when an HTTP session expires;

FIG. 9 is a processing flow diagram when global session information is taken over; and

FIG. 10 is a processing flow diagram when a session information management server fails.

### DETAILED DESCRIPTION OF THE EMBODIMENTS

In the following, a session information management system according to one embodiment of the present invention will be described with reference to the accompanying drawings in the order of General Configuration, Operation Outline, Data Structures, and Processing Procedures.

<<General Configuration>>

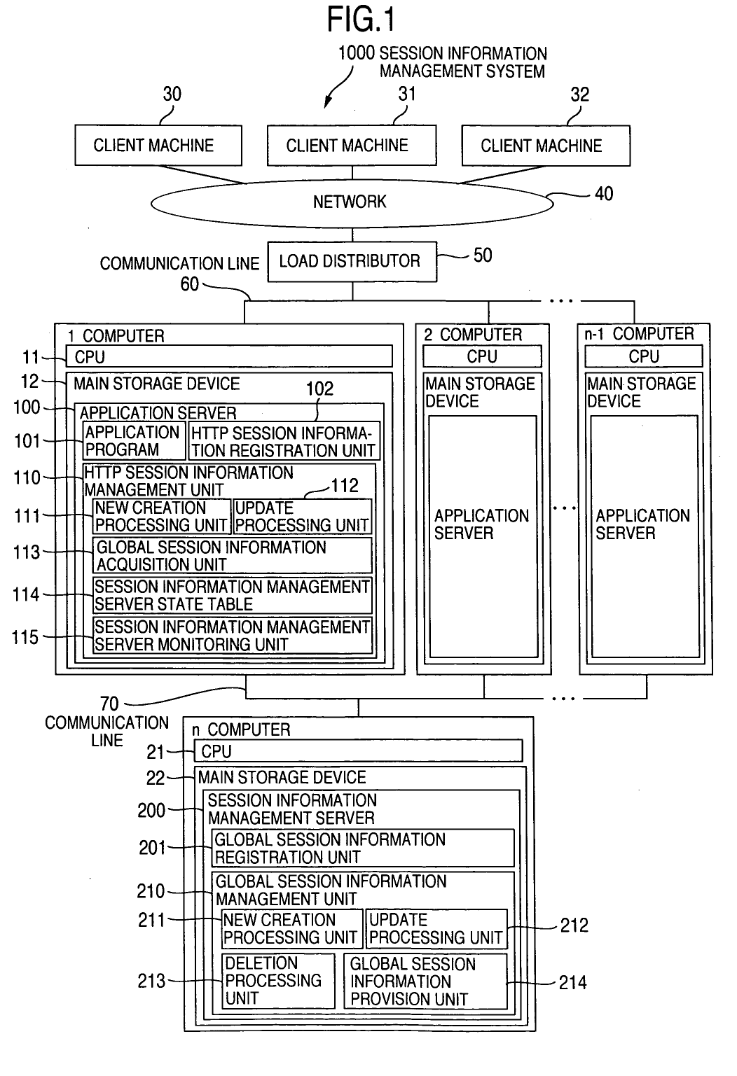

FIG. 1 is a block diagram illustrating the general configuration of the session information management system according to one embodiment. The session information management system 1000 comprises client machines 30-32, a network 40, a load distributor 50, and computers 1-n.

The client machines 30-32, provided for use by clients (users), are, implemented, for example, by personal computers (PC), and may also be called terminals or user terminals.

The network 40 is a wide area communication network, for example, the Internet, and serves as a means for transmitting/receiving data and requests therethrough. The client machines 30-32 are connected to the load distributor 50 through the network 40.

The load distributor 50 distributes accesses from the client machines 30-32 to the computers 1-(n−1) through communication lines 60, and is a so-called load balancer.

The computer n is connected to the computers 1-(n−1) through a communication line 70.

<Computers 1-(n−1) (First Computers)>

The computers 1-(n−1) are arranged in a cluster configuration, and accept accesses from the client machines 30-32 distributed by the load distributor 50 and process the distributed accesses. The computers 1-(n−1) can be implemented by physical computers, information processing apparatuses, virtual computers, logical servers, or the like to carry out the processing. The computers 1-(n−1) are similar in configuration of both hardware and software, so that the computer 1 will be given as a representative example in the following description.

The computer 1 comprises a CPU (Central Processing Unit) 11, and a main storage device 12.

The CPU 11 performs a variety of operational processing based on data received from the load distributor 50, programs stored in the main storage device 12, and the like.

The main storage device 12 comprises memories such as RAM (Random Access Memory) and ROM (Read Only Memory), a hard disk drive, or the like for storing a variety of information. The main storage device 12 stores an application server 100 which is implemented by a program.

The application server 100 comprises an application program 101, an HTTP session information registration unit 102, and an HTTP session information management unit 110.

The application program 101 serves accesses from the client machines 30-32, and can be implemented by an object, a process, or a thread. Alternatively, the application program 101 may be a business program.

The HTTP session information registration unit 102 is a program for registering session information resulting from accesses from the client machines 30-32.

The HTTP session information management unit 110 is a program for managing information registered in the HTTP session information registration unit 102, and comprises a new creation processing unit 111, an update processing unit 112, a global session information acquisition unit 113, a session information management server state table 114, and a session information management server monitoring unit 115. Each of these processing units may be implemented by a program, an object, a process, or a thread.

The new creation processing unit 111 is a program for creating a new HTTP session in the HTTP session information registration unit 102. A notation of “HTTP session” indicates a storage area for associated session information in the HTTP session information registration unit 102, while a notation of “HTTP session information” indicates session information stored in the HTTP session.

The update processing unit 112 is a program for requesting the client machines 30-32 and session information management server 200 for a transmission and an update of global session information in response to the processing on session information performed in the application server 100.

The global session information acquisition unit 113 is a program for acquiring information from a global session information provision unit 214 of the session information management server 200, later described.

The session information management server state table 114 stores the address of the session information management server 200, the presence or absence of a failure, and the like.

The session information management server monitoring unit 115 is a program for detecting the presence or absence of a failure in the session information management server 200 with the aid of a regular transmission function of the session information management server 200 or the like, and writing the result of the detection into the session information management server state table 114.

<Computer n (Second Computer)>

The computer n has similar hardware to the computers 1-(n−1), and comprises a CPU 21 and a main storage device 22. The main storage device 22 stores a session information management server 20 which is a program for managing session information related to the computers 1-(n−1).

The session information management server 200 comprises a global session information registration unit 201, and a global session information management unit 210.

The global session information registration unit 201 is a program for receiving and registering part of HTTP session information of each application server 100, which must be taken over to other application servers 100, from each application server 100.

The global session information management unit 210 comprises a new creation processing unit 211, an update processing unit 212, a deletion processing unit 213, and a global session information provision unit 214.

The new creation processing unit 211 is a program which receives a request from the new creation processing unit 111 of the application server 100 to create a global session in the global session information registration unit 201.

The update processing unit 212 is a program which receives a request from the update processing unit 112 of the application server 100 to add, update, and delete global information to, in, and from the global session information registration unit 201. A notation of “global session” indicates a storage area for session information in the global session information registration unit 201, while a notation of “global session information” indicates session information stored in the global session.

The deletion processing unit 213 is a program for deleting a global session which expires in the global session information registration unit 201.

The global session information provision unit 214 is a program which receives a request from the global session information acquisition unit 113 of the application server 100 to transmit necessary global session information to the global session information acquisition unit 113 with reference to the global session information registration unit 201.

Each of the processing units can be implemented by an object, a thread, or a process.

<<Operation Outline>>

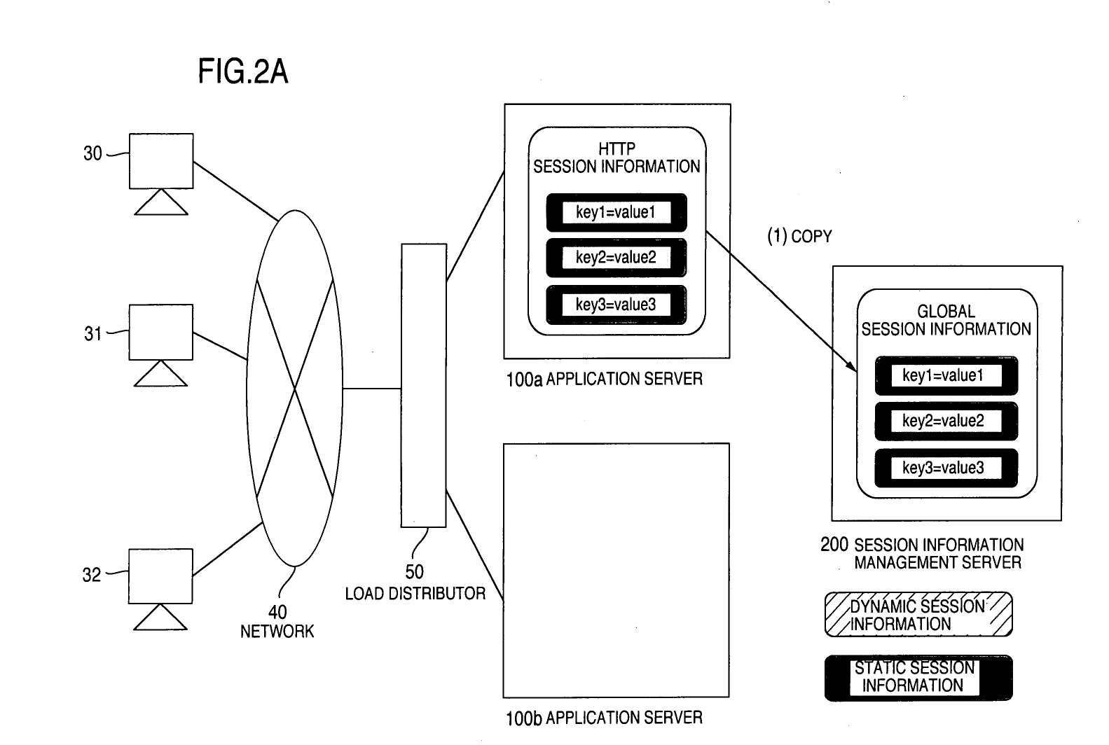

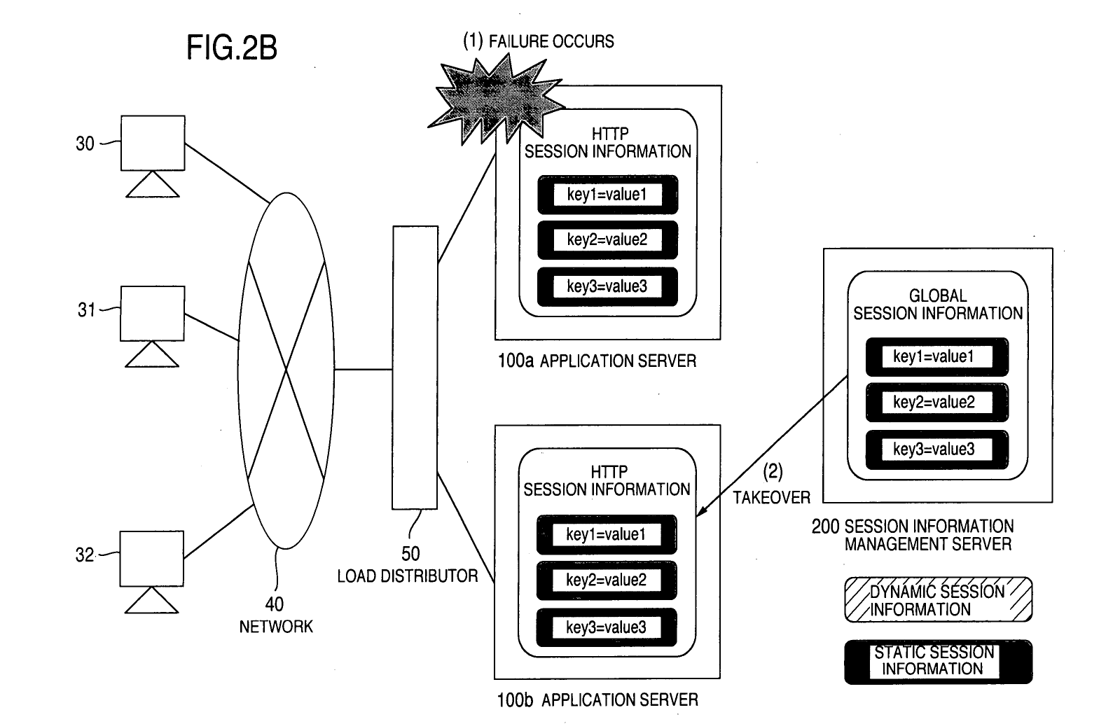

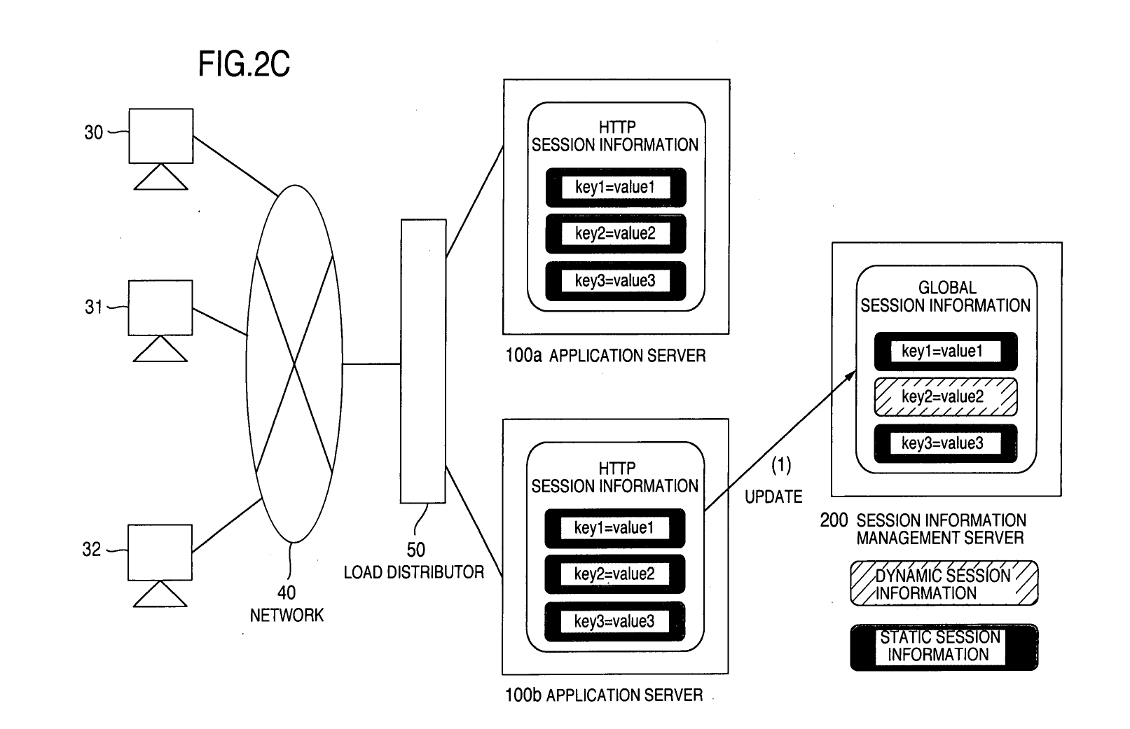

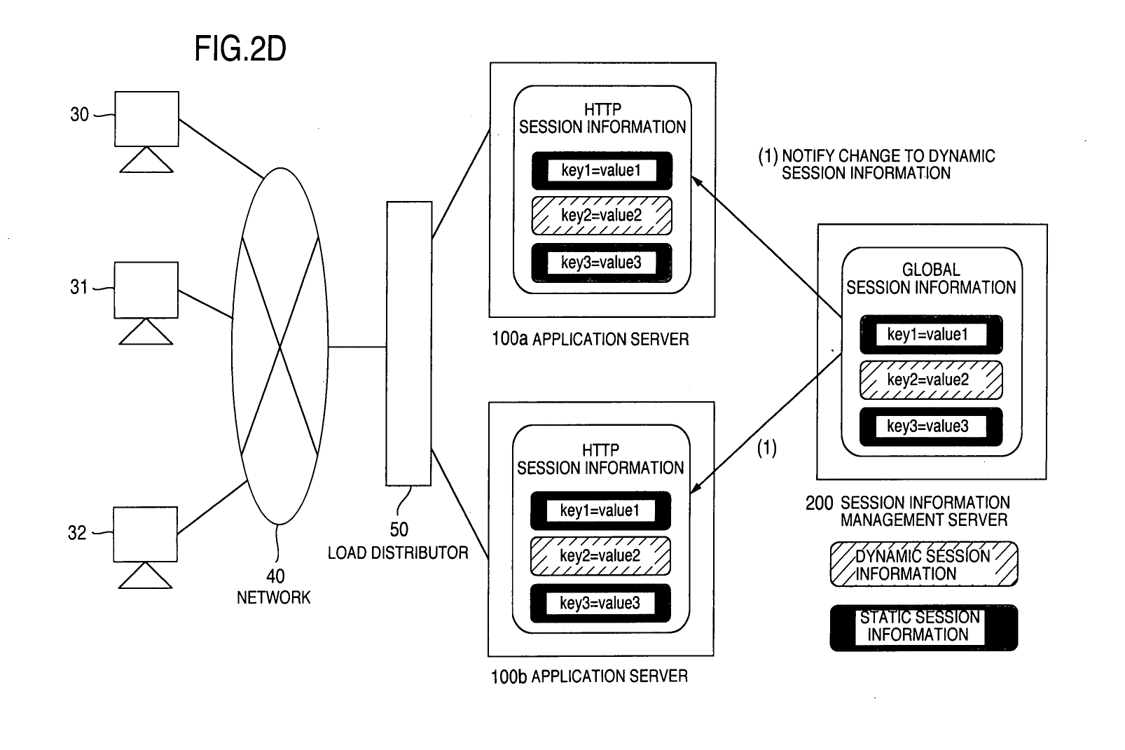

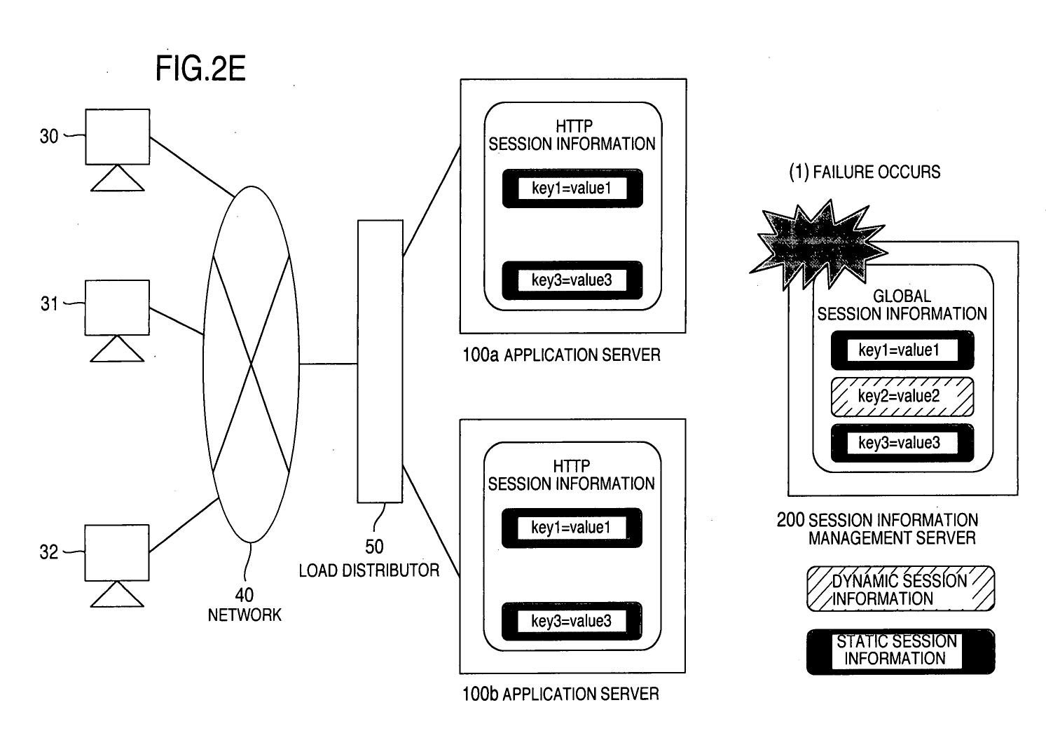

Next, a description will be given of the outline of operations in the session information management system 1000. Here, referring to FIGS. 2A to 2E, described below is the outline of operations for taking over session information between application servers 100.

In each of FIGS. 2A-2E, the client machines 30-32 are connected to application servers 100a, 100b through the network 40 and load distributor 50, while the application servers 100a, 100b are connected to the session information management server 200. The application servers 100a, 100b are programs similar to the application server 100 in FIG. 1.

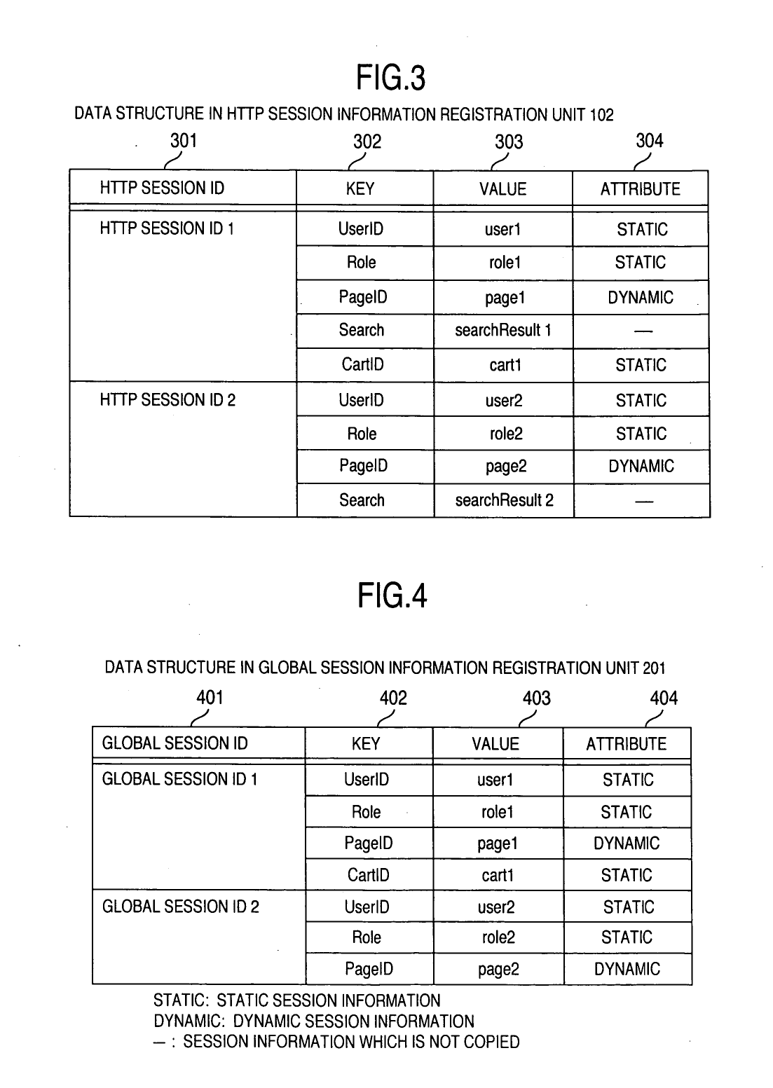

First, as illustrated in FIG. 2A, the application server 100a copies HTTP session information (key1=value1, key2=value2, key3=value3), which should be taken over to other application servers, among HTTP session information created in response to an access from any of the client machines 30-32 (for example, the client machine 30), such that it is included in global session information of the session information management server 200 (FIG. 2A(1)). Specifically, the application server 100a transmits its HTTP session information to the session information management server 200 which then registers the received HTTP session information as global session information. Key1-key3 and value1-value3 will be described with reference to FIG. 3, later described.

In this event, the HTTP session information (key1=value1, key2=value2, key3=value3) created by the application server 100a, and the global session information (key1=value1, key2=value2, key3=value3) copied to the session information management server 200 are given the attribute of static information indicative of a static nature, out of two attributes (attribute of static information and attribute of dynamic information), by the session information management server 200. The attribute of static information means that HTTP session information has not been updated. The attribute of dynamic information means that HTTP session information has been updated.

In the HTTP session information, “key” indicates an entry, and “value” indicates a value corresponding to the entry, details of which will be described in connection with FIG. 3.

Subsequently, if the application server 100a fails as illustrated in FIG. 2B (FIG. 2B(1)) during the processing of the application server 100a illustrated in FIG. 2A, the load distributor 50 switches the access from the client machine 30 to the application server 10b, and the session information management server 200 takes over the global session information (key1=value1, key2=value2, key3=value3) to the application server 100b with the attribute of static information being maintained (FIG. 2B(2)).

In this way, the client machine 30, which has accessed the application server 100a, can successively switch the access to the application server 100b without the need for operations such as re-login. Consequently, the processing for the client machine 30 is continued in the application server 10b.

Then, as illustrated in FIG. 2C, when the HTTP session information of the application server 100b is rewritten and updated, the application server 100b transmits information on the update to the session information management server 200. In FIG. 2C, assume, for example, that “key2” is updated from “value 2” to “value 2′”.

Upon receipt of the update information, the session information management server 200 updates “key2” in the global session information” from “value2” to “value 2′” based on the update information, and also changes the attribute of “key2” to the attribute of dynamic information.

At this time, the attribute of “key2” in the HTTP session information of the application server 100b remains unchanged from the attribute of static information.

Subsequently, as illustrated in FIG. 2D, the session information management server 200 notifies the application servers 100a, 100b that the attribute of “key2” has been changed from the attribute of static information to the attribute of dynamic information.

In response, the application server 100a changes the attribute of “key2” from the attribute of static information to the attribute of dynamic information. The application server 100b also changes the attribute of “key2” from the attribute of static information to the attribute of dynamic information.

In this way, the session information management server 200 transmits only the changed attribute of “key2” to the application server 100b, without transmitting the contents of the change, thereby making it possible to reduce a processing burden on each server. In other words, this change in attribute has to be transmitted only once at the time of the change, and even if the same session information is rewritten at a later time, no transmission has to be made from the session information management server 200 to the application server 10b.

In the application server 10b, the attribute of “key2” is changed from the attribute of static information to the attribute of dynamic information at the timing at which the application server 100b receives a notification from the session information management server 200, as described above, rather than the timing at which “key2” is actually updated, for purposes of maintaining the consistency between the application servers 100a and 10b. More specifically, this is intended to avoid an inconsistent state in which “key2” has the attribute of dynamic information in the application server 100b even though “key2” has the attribute of static information in the application server 100a in FIG. 2C.

Next, in FIG. 2E, when the session information management server 200 fails, the application servers 100a, 100b can maintain the consistency therebetween by deleting the HTTP session information (“key2”) having the attribute of dynamic information and leaving the HTTP session information (“key1” and “key3”) having the attribute of static information.

Specifically, a user ID used for login or the like, for example, will never be updated, and therefore remains as HTTP session information having the attribute of dynamic information in the application servers 100a, 100b. On the other hand, a page ID of a screen or the like, for example, changes to HTTP session information having the attribute of dynamic information, if it is updated even once, so that it will be deleted from the application servers 100a, 100b when the session information management server 200 fails. However, this is information of low importance, as compared with the user ID and the like, so that the foregoing strategy can provide benefits with regard to the preservation of the consistency between application servers, the processing efficiency of the entire session information management system 1000, and the like.

Also, while the foregoing embodiment has been described in connection with the application server 100 which has failed, the present invention can also be applied to a degeneracy operation in which one or a plurality of the application servers 100 are deleted. Further, even when an additional application server 100 is installed, the additional application server 100 can also utilize a session by copying session information from the session information management server 200.

<<Data Structures>>

<Data Structure in HTTP Session Information Registration Unit>

Next, a data structure used by the HTTP session information registration unit 102 in the application server 100 shown in FIG. 1 will be described with reference to FIG. 3. FIG. 3 is a table showing the data structure in the HTTP session information registration unit 102.

In FIG. 3, two pieces of session information are shown to include four entries: HTTP session ID 301, KEY 302, VALUE 303, and attribute 304.

The HTTP session ID 301 is an identifier for uniquely identifying a session within the associated application server 100, and shows herein two ID's, HTTP session ID 1 and HTTP session ID 2.

KEY 302 indicates the type of each of pieces of information which make up the session information. “UserID” is used by a client (user) for logging in on any of the client machines 30-32. “Role” means rights given to the client machines 30-32 by “UserID” or the like. “PageID” identifies a screen which is viewed by a client (user) on the client machine 30-32. “Search” indicates the result of a search. “CartID” indicates the ID of a cart which receives articles on the screen when an on-line shopping service or the like is provided to a client of the application program 101 in the application server 100 of FIG. 1.

VALUE 303 indicates actual values corresponding to KEY 302, and stores herein “user1,” “rolel,” “pagel,” “searchResultl,” and “cartl” in order from the top.

The attribute 304 indicates an attribute associated with each information represented by KEY 302. There are two types of attributes, the attribute of static information and the attribute of dynamic information, as mentioned above, and information is labeled “-” when it does not belong to either of the two attributes.

Session information which is given the attribute of static information or the attribute of dynamic information should be taken over to other application servers 100, and in each application server 100, session information which should be taken over has been determined depending on selection conditions which have been previously set in accordance with the type of KEY 302.

The attribute of static information indicates information which is not changed in a session among pieces of information which should be shared by the respective application servers, as has been described in connection with FIGS. 2A-2E.

The attribute of dynamic information in turn indicates information which is changed in a session among pieces of information which should be shared by the respective application servers.

Information labeled “-” indicates that the information need not be shared by the respective application servers.

<Data Structure in Global Session Information Registration Unit>

Next, a data structure used by the global session information registration unit 201 in the session information management server 200 of FIG. 1 will be described with reference to FIG. 4. FIG. 4 is a table showing the data structure in the global session information registration unit 201.

In FIG. 4, two pieces of information are stored in a form corresponding to four entries: global session ID 401, KEY 402, VALUE 403, and attribute 404.

The global session ID 401 is an identifier for uniquely identifying a session within the session information management server 200, and shows herein two ID's, global session ID 1 and global session ID 2.

KEY 402, VALUE 403, and attribute 404 are similar to KEY 302, VALUE 303, and attribute 304 in FIG. 3, respectively, so that a description thereon is omitted.

<<Processing Procedures>>

Next, a description will be given of specific processing procedures of the session information management system 1000.

<Process 1>

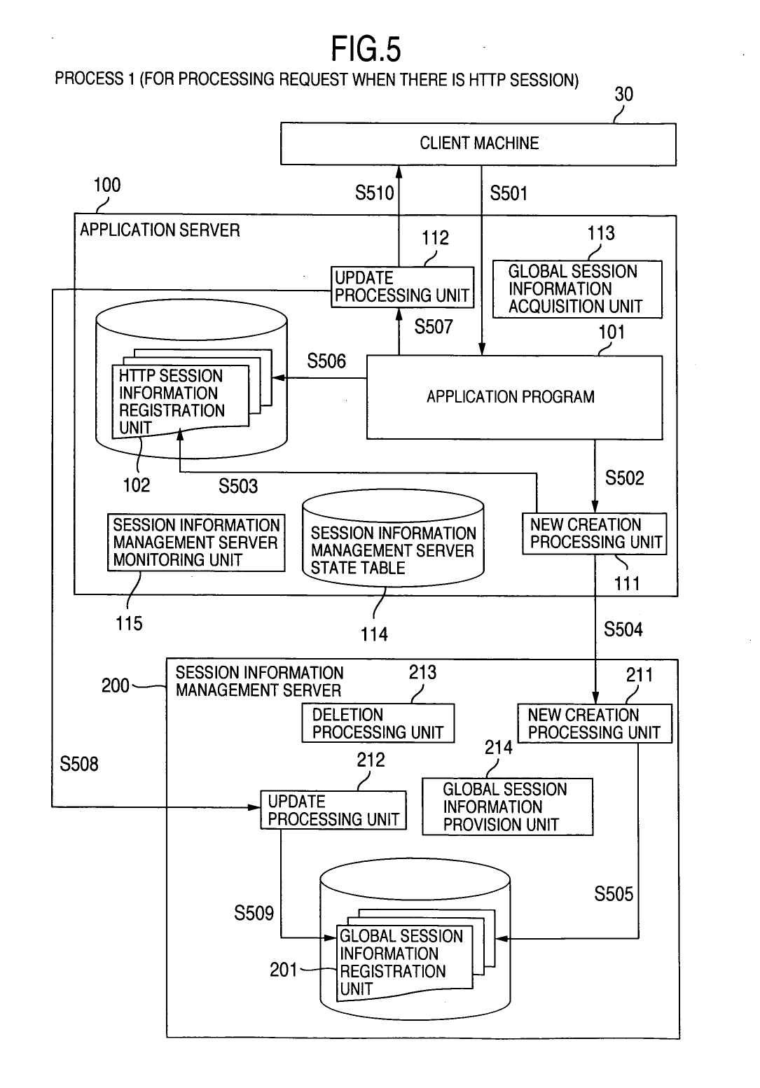

Referring first to FIG. 5, Process 1 (for processing a request when there is no HTTP session) will be described in detail. Assume herein that the process is started from a state where the HTTP session information registration unit 102 has not created an HTTP session, and the global session information registration unit 201 has not created a global session.

Process 1 creates session information for the application server 100 and session information management server 200, respectively, and corresponds to the operations in FIG. 2A (the application server 100 in FIG. 5 corresponds to the application server 100a in FIG. 2).

FIG. 5 is a processing flow diagram under the aforementioned conditions.

First, the client machine 30 requests the application program 101 to process a request (S501).

The application program 101 requests the new creation processing unit 111 to newly create an HTTP session (S502).

The new creation processing unit 111 creates an HTTP session in the HTTP session information registration unit 102 (S503), and issues a global session ID 401 (see FIG. 4) corresponding to this HTTP session.

The new creation processing unit 111 requests the new creation processing unit 211 to create a global session corresponding to the global session ID 401 (S504)

The new creation processing unit 211 creates a global session corresponding to the global session ID 401 in the global session information registration unit 201 (S505).

The application program 101 updates information which should be updated, if any, with reference to the HTTP session information registration unit 102 (S506).

The application program 101 requests the update processing unit 112 to transmit a response to the client machine 30 (S507).

The update processing unit 112 requests the update processing unit 212 to update the global session information registration unit 201 (S508).

The update processing unit 212 updates information which should be updated, if any, with reference to the global session information registration unit 201 (S509).

The update processing unit 112 transmits a response including the global session ID 401 (FIG. 4) to the client machine 30 (S510). Upon receipt of the response, the client machine 30 registers the global session ID 401 (FIG. 4) in itself.

<Process 2>

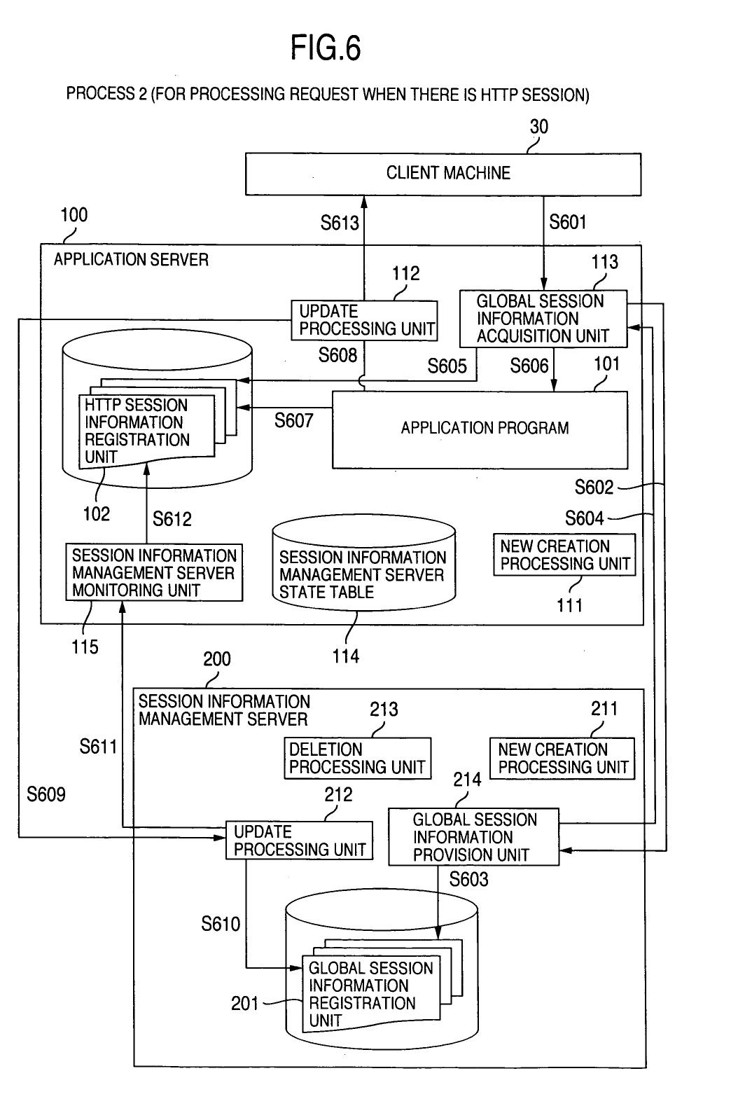

Referring next to FIG. 6, Process 2 (for processing a request when there is an HTTP session) will be described in detail. Assume herein that the process is started from a state where the HTTP session information registration unit 102 has created an HTTP session, and the global session information registration unit 201 has created a global session.

Process 2 changes the attribute of session information from the attribute of static information to the attribute of dynamic information, and corresponds to the operations in FIG. 2C and FIG. 2D (the application server 100 in FIG. 6 corresponds to the application server 100b in FIG. 2).

FIG. 6 is a processing flow diagram under the aforementioned conditions.

First, the client machine 30 requests the global session information acquisition unit 113 to process a request (S601).

The global session information acquisition unit 113 requests the global session information provision unit 214 to provide latest global session information (S602).

The global session information provision unit 214 confirms whether or not global session information has been updated with reference to the global session information registration unit 201 (S603).

The global session information provision unit 214 transmits the latest global session information to the global session information acquisition unit 113 when the global session information has been updated, and otherwise transmits a message which informs that the global session information has not been updated (S604).

The global session information acquisition unit 113 updates corresponding HTTP session information in HTTP session information registration unit 102 (S605) when it has received the latest global session information at S604.

The global session information acquisition unit 113 requests the application program 101 to process the request (S606).

The application program 101 updates information which should be updated, if any, with reference to the HTTP session information registration unit 102 (S607).

The application program 101 requests the update processing unit 112 to transmit a response to the client machine 30 (S608).

The update processing unit 112 requests the update processing unit 212 to update the global session information registration unit 201 (S609).

The update processing unit 212 updates information which should be updated, if any, with reference to the global session information registration unit 201. In this event, the update processing unit 212 updates information belonging to the attribute of static information by changing the attribute to the attribute of dynamic attribute (S610), and requests all the application servers 100 to change the attribute of the information (from the attribute of static information to the attribute of dynamic information) (S611).

The session information management server monitoring unit 115 updates the attribute of the information from the attribute of static information to the attribute of dynamic information (S612).

The update processing unit 112 transmits a response to the client machine 30 (S613).

With the operations of Process 2, information which has been changed can be changed from the attribute of static information to the attribute of dynamic information.

<Process 3>

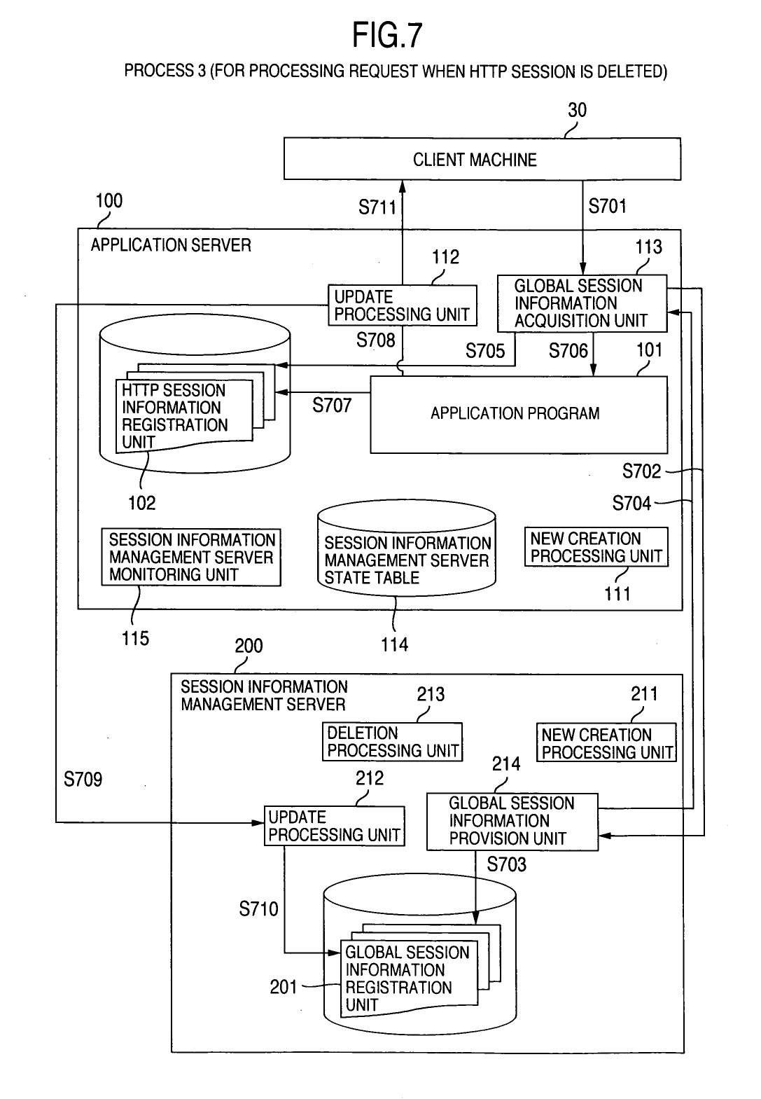

Referring next to FIG. 7, Process 3 (for processing a request when an HTTP session is deleted) will be described in detail. Assume herein that the process is started from a state where the HTTP session information registration unit 102 has created an HTTP session, and the global session information registration unit 201 has created a global session.

Process 3 deletes respective session information in the HTTP session information registration unit 102 and global session information registration unit 201 in response to a request from the client machine 30.

FIG. 7 is a processing flow diagram under the aforementioned conditions.

First, the client machine 30 requests the global session information acquisition unit 113 to process a request (S701).

The global session information acquisition unit 113 requests the global session information provision unit 214 to provide latest global session information (S702).

The global session information provision unit 214 confirms whether or not the global session information has been updated with reference to the global session information registration unit 201 (S703).

The global session information provision unit 214 transmits the latest global session information to the global session information acquisition unit 113 when the global information has been updated, and otherwise transmits a message which informs that the global session information has not been updated (S704).

The global session information acquisition unit 113 updates corresponding HTTP session information in the HTTP session information registration unit 102 when it has received the latest global session information at S704 (S705).

The global session information acquisition unit 113 requests the application program 101 to process the request (S706).

The application program 101 deletes the HTTP session in the HTTP session information registration unit 102 (S707).

The application program 101 requests the update processing unit 112 to transmit a response to the client machine 30 (S708).

The update processing unit 112 requests the update processing unit 212 to delete the global session information from the global session information registration unit 201 (S709).

The update processing unit 212 deletes the global session information from the global session information registration unit 201 (S710).

The update processing unit 112 transmits a response to the client machine 30 for instructing the same to delete the global session ID 401 (FIG. 4)(S711).

<Process 4>

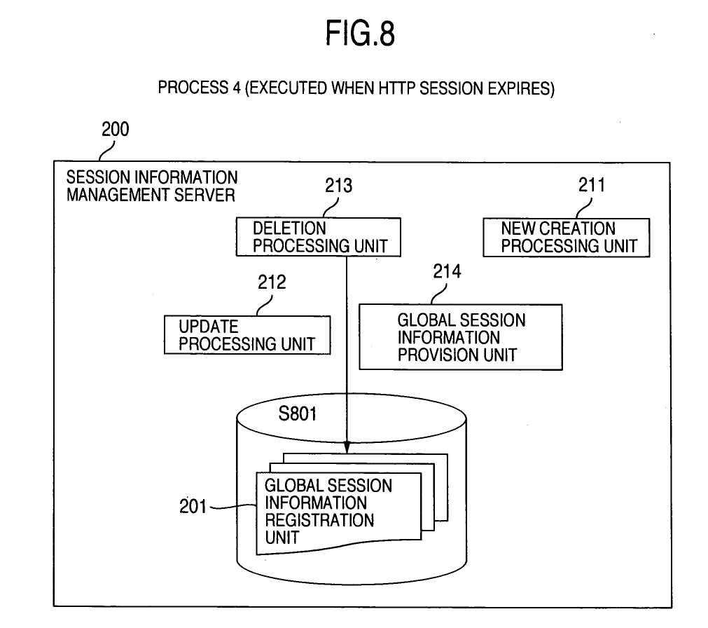

Referring next to FIG. 8, Process 4 (executed when an HTTP session expires) will be described in detail. Process 4 is represented by a processing flow diagram which illustrates operations in the session information management server 200 when an HTTP session expires.

When the deletion processing unit 213 detects that an HTTP session possessed thereby expires from expiration date information on the HTTP session, the deletion processing unit 213 deletes a global session corresponding to this HTTP session from the global session information registration unit 201 (S801).

The expiration date information on an HTTP session may not be held by the deletion processing unit 213 itself, but may be stored in a dedicated table (not shown) or the like, such that the deletion processing unit 213 references the dedicated table.

With the operations of Process 4, it is possible to avoid unnecessary sessions from accumulating in the session information management server 200.

<Process 5>

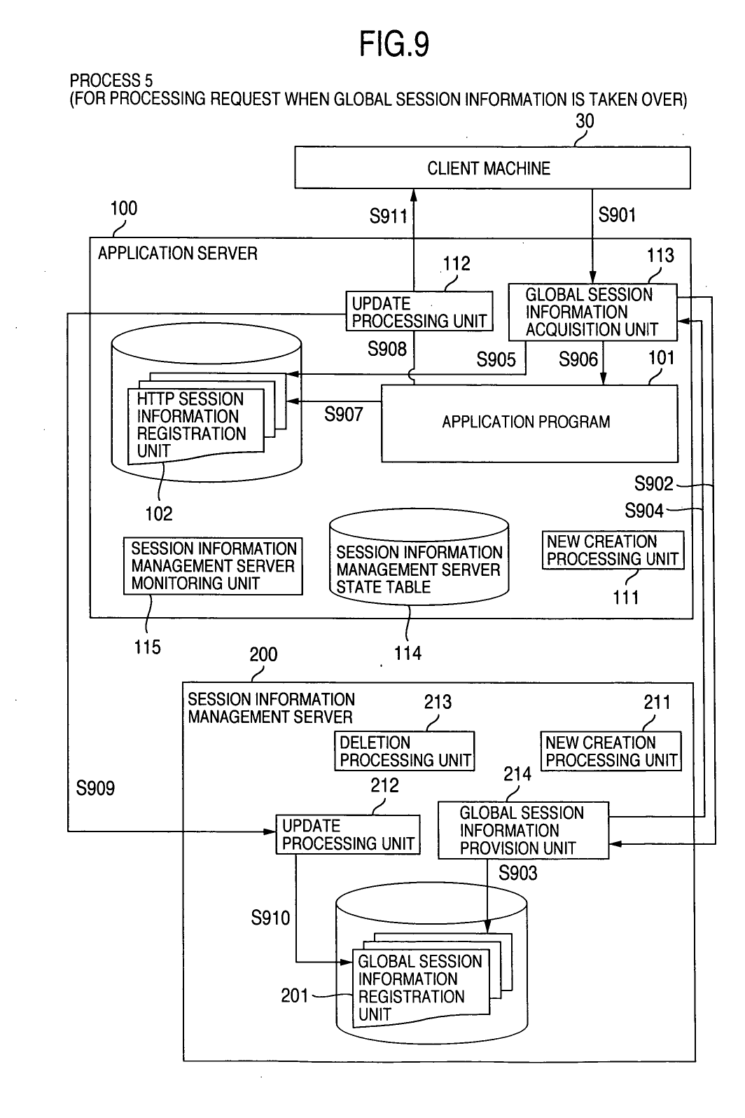

Referring next to FIG. 9, Process 5 (for processing a request when global session information is taken over) will be described in detail. Assume herein that the process is started from a state where the HTTP session information registration unit 102 has not created an HTTP session, and the global session information registration unit 201 has created a global session.

Process 5 is executed when the application server 100 which processes a request is switched to another one, and corresponds to the operations in FIG. 2B (the application server 100 in FIG. 9 corresponds to the application server 100b in FIG. 2).

FIG. 9 is a processing flow diagram under the aforementioned conditions.

Process 5 starts immediately after the application server 100 which processes a request from the client machine 30 is switched due to a failure.

First, the client machine 30 requests the global session information acquisition unit 113 to process a request (S901).

When the HTTP session information registration unit 102 does not store an HTTP session corresponding to an HTTP session ID in request information from the client machine 30, global session information acquisition unit 113 requests the global session information provision unit 214 to provide global session information corresponding to a global session ID in the request information (S902).

The global session information provision unit 214 acquires the global session information from the global session information registration unit 201 (S903).

The global session information provision unit 214 transmits the global session information to the global session information acquisition unit 113 (S904).

The global session information acquisition unit 113 stores the global session information in the HTTP session information registration unit 102 as new HTTP session information (S905).

The global session information acquisition unit 113 requests the application program 101 to process the request (S906).

The application program 101 processes the request using HTTP session information in the HTTP session information registration unit 102 (S907).

The application program 101 requests the update processing unit 112 to transmit a response to the client machine 30 (S908).

The update processing unit 112 requests the update processing unit 212 to update the global session information (S909).

The update processing unit 212 updates the global session information in the global session information registration unit 201 (S910).

The update processing unit 112 transmits a response to the client machine 30 (S911).

In this way, the application server 100 which takes over the processing of the request from the client machine 30 can take over necessary session information from the session information management server 200. This permits the client machine 30 to smoothly continue an access (request) to the application server 100 without performing laborious operations such as re-login.

<Process 6>

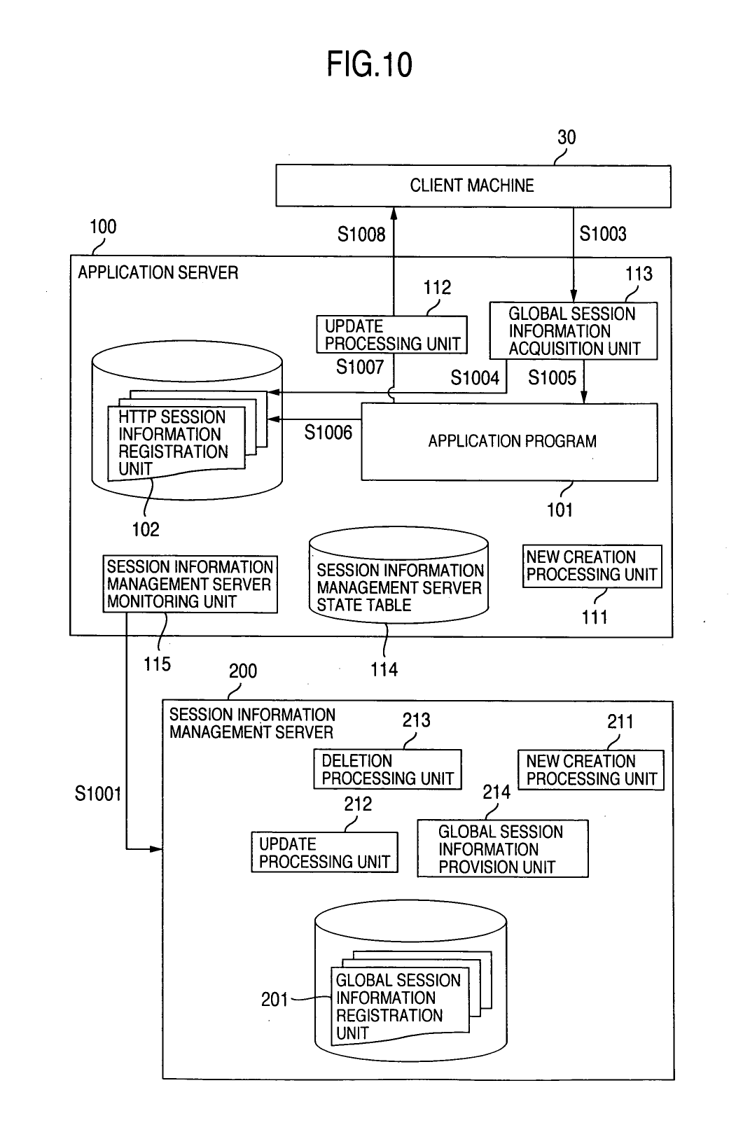

Referring next to FIG. 10, Process 6 (for processing a request when session information management server 200 fails) will be described in detail. Assume herein that the process is started from a state where the HTTP session information registration unit 102 has created an HTTP session, and the global session information registration unit 201 has created a global session.

Process 6 is executed when the session information management server 200 fails, and corresponds to the operations in FIG. 2E (the application server 100 in FIG. 10 corresponds to either the application server 100a or 100b).

FIG. 10 is a processing flow diagram under the aforementioned conditions.

The session information management server monitoring unit 115 detects that the session information management server 200 has failed (S1001). A failure can be detected, for example, by the session information management server monitoring unit 115 which does not receive a regular transmission from the session information management server 200 to determine that the session information management server 200 has failed. However, the detection is not limited to this way, but may be made in another way.

The session information management server monitoring unit 115 rewrites the state of the session information management server 200 to “failure” in the session information management server state table 114 (S1002).

The client machine 30 requests the global session information acquisition unit 113 to process a request (S1003).

Since the session information management server 200 has failed, the global session information acquisition unit 113 deletes information having the attribute of dynamic information from HTTP session information corresponding to a request which has been processed at the time the session information management server 200 failed (S1004).

The processing at S1004 is performed to maintain the consistency among a plurality of application servers 100. Specifically, since session information can no longer be shared among the application servers 100 due to the failure in the session information management server 200, an inconsistent state is avoided among the plurality of application servers 100 by deleting information having the attribute of dynamic information which is not consistent in contents among the plurality of application servers 100. On the other hand, information having the attribute of static information need not be deleted because it is not changed. Also, the information having the attribute of static information is not deleted because this can eliminate laborious operations such as re-login in the client machine 30 even when one application server 100 is switched to another, thus providing a highly convenient session information management system 1000.

Turning back to Process 6 in FIG. 10, the global session information acquisition unit 113 requests the application program 101 to process the request (S1005).

The application program 101 processes the request using remaining information having the attribute of static information in HTTP session information in the HTTP session information registration unit 102 (S1006).

The application program 101 requests the update processing unit 112 to transmit a response to the client machine 30 (S1007).

The update processing unit 112 transmits a response to the client machine 30 (S1008).

In this way, according to the session information management system 1000 of this embodiment, information in the session information to be taken over is classified into two according to the attribute (the attribute of static information and the attribute of dynamic information), and shared by the application server 100 and session information management server 200. Then, if the session information management server 200 fails, the information having the attribute of dynamic information is deleted while the information having the attribute of static information is left in the application server, thereby making it possible to maintain the consistency of the session information among a plurality of application servers 100.

Also, when session information is stored in the session information management server from the application server 100 for the first time, all the session information is set to the attribute of static information, and subsequently, information which is changed even once is changed to information having the attribute of dynamic information. In this way, an appropriate attribute can be automatically determined for and given to each information, so that the resulting session information management system 1000 is highly convenient with the elimination of laborious operations such as previous registration of the attribute on an information-by-information basis. However, if there is a small number of types of session information (the type of KEY 302 in FIG. 3), the attributes related to individual pieces of session information may be manually set beforehand.

While the description of the embodiment is now concluded, the present invention is not limited to the foregoing embodiment. For example, for distributing accesses from client machines to a plurality of application servers, a round-robin method or the like may be employed instead of using the load distributor. Otherwise, the present invention can be modified in specific configuration as appropriate without departing from the spirit and scope of the invention.

It should be further understood by those skilled in the art that although the foregoing description has been made on embodiments of the invention, the invention is not limited thereto and various changes and modifications may be made without departing from the spirit of the invention and the scope of the appended claims.

1. A session information management method in a session information management system which comprises a plurality of first computers each for performing a process in response to a request from a terminal, and a second computer for managing session information on the request processed by each of said first computers, said method comprising the steps of:
said second computer giving an attribute to the session information for indicating the presence or absence of the session information; and
each of said first computers continuing a process in response to a request from said terminal based on the attribute of the session information given by said second computer.

2. A session information management method according to claim 1, wherein:
each of said first computers selects the session information to which said second computer gives the attribute based on a previously set selection condition.

3. A session information management method according to claim 1, wherein:
upon receipt of session information which updates the registered session information when said first computer performs a process in response to a request from said terminal, said first computer transmits the session information to said second computer; and
said second computer changes the attribute of the session information transmitted from said first computer to the attribute of dynamic information indicative of an update, and notifies each of said first computers of the change to the attribute of dynamic information of the changed session information.

4. A session information management method according to claim 3, wherein:
after one of said first computers has been switched to another first computer, when said other first computer performs a process requested from the terminal to be processed, said other first computer receives and registers session information managed in said second computer together with a predetermined attribute when a session of the request is not registered.

5. A session information management method according to claim 3, wherein:
each of said first computers deletes session information having the attribute of dynamic information in the session information when said each first computer detects that said second computer stops operating.

6. A session information management system comprising:
a plurality of first computers each for performing a process in response to a request from a terminal; and
a second computer for managing session information on the request processed by each of said first computers,
wherein said second computer gives the session information an attribute indicative of the presence or absence of an update in the session information; and
said first computer continues the process in response to the request from said terminal based on the attribute of the session information given by said second computer.

7. A second computer for managing session information on requests processed by a plurality of first computers in response to requests from terminals, said second computer comprising a storage unit and a processing unit, wherein:
said processing unit receives the session information from each of said first computers, gives the received session information an attribute indicative of the presence or absence of an update in the session information, and stores the session information in said storage unit together with the attribute, and
said processing unit associates session information read from said storage unit with its attribute, transmits the session information together with the attribute to a predetermined first computer to allow said first computer to continue a process in response to a request from said terminal based on the session information which has been given the attribute.

8. A session information management program for causing a computer to execute the session information management method according to claim 1.
